(19) United States
(12) Patent Application Publication
(10) Pub. No.: US 2025/0348561 A1
(43) Pub. Date: Nov. 13, 2025

(54) DETECTING DIGITAL MEDIA PIRACY VIA VIEWER INTERACTION

(71) Applicant: Mysten Labs, Inc.,, Palo Alto, CA (US)

(72) Inventors: Konstantinos Chalkias, Dubai (AE); Ryan Servatius, Seattle, WA (US); Adeniyi Abiodun, San Jose, CA (US)

(73) Assignee: Mysten Labs, Inc.,, Palo Alto, CA (US)

(21) Appl. No.: 19/205,493

(22) Filed: May 12, 2025

Related U.S. Application Data
(60) Provisional application No. 63/646,264, filed on May 13, 2024.

(51) Int. Cl. G06F 21/10; G06F 3/0482

(52) U.S. Cl. CPC G06F 21/106; G06F 3/0482

(57) ABSTRACT

The present technology significantly enhances digital media piracy detection by integrating personalized viewer interactions into the broadcasting content. Through the unique customization of SMS, QR codes, trivia shuffling, and voice commands, the present technology not only detects piracy with high precision but also enhances viewer engagement and maintains robust privacy and security through advanced blockchain and zero-knowledge proof technologies.

### CROSS-REFERENCE TO RELATED APPLICATIONS

This application claims the benefit of and priority to U.S. provisional application No. 63/646,264 filed on May 13, 2024, which is expressly incorporated by reference herein in its entirety.

### BACKGROUND

The advent of digital content distribution has revolutionized the way in which multimedia, software, and literature are disseminated across the globe. This process entails the delivery of digital media, including music, video, eBooks, and applications, through online platforms, thereby enabling instantaneous access to content for consumers. Unfortunately, digital content distribution is susceptible to unauthorized distribution, such as digital piracy, an illicit activity where copyrighted digital content is copied, distributed, or accessed without authorization or compensation to the copyright holders. The ease of copying and transmitting digital files across the Internet, often with minimal quality loss, has made digital content a prime target for piracy. This not only results in significant financial losses for content creators and distributors but also undermines the integrity of copyright laws and disincentives content production.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example system for implementing an unauthorized distribution detection system in accordance with some embodiments of the present technology.

FIG. 2 illustrates an example routine for detecting unauthorized distribution of digital content in accordance with some embodiments of the present technology.

FIG. 3 illustrates a blockchain transaction process in accordance with some embodiments of the present technology.

FIG. 4 illustrates a blockchain formation 400 in accordance with some embodiments of the present technology.

FIG. 5 illustrates a blockchain 500 in accordance with some embodiments of the present technology.

FIG. 6 shows an example of a system for implementing some aspects of the present technology.

### DETAILED DESCRIPTION

The advent of digital content distribution has revolutionized the way in which multimedia, software, and literature are disseminated across the globe. This process entails the delivery of digital media, including music, video, eBooks, and applications, through online platforms, thereby enabling instantaneous access to content for consumers. Unfortunately, digital content distribution is susceptible to digital piracy, an illicit activity where copyrighted digital content is copied, distributed, or accessed without authorization or compensation to the copyright holders. The case of copying and transmitting digital files across the Internet, often with minimal quality loss, has made digital content a prime target for piracy. This not only results in significant financial losses for content creators and distributors but also undermines the integrity of copyright laws and disincentives content production.

The present technology addresses these problems by distributing digital content items with interactable elements. These interactable elements are configured to elicit interaction from user accounts that are viewing the content items. In some embodiments, the interactable elements are targeted to the user account requesting the content item. In some embodiments, the interactable elements are unique for different distributions of the content item.

When a user interacts with the interactable element, a data trail is generated as the user account requests access to the resource to which the interactable element points. The data trail results in attributes of the interaction with the interactable element, which can be analyzed to identify when the content item has been distributed beyond the intended user account to which the content item was served.

In some embodiments, interactions with the interactable element can be recorded on a blockchain or other immutable ledger to create an audit trail of attributes of the interaction when the interactable element is used to initiate an interaction.

In some embodiments, while detailed data might be learned from user accounts that can be useful in the identification of unauthorized copying or sharing of the content item, it is preferable that the present technology still preserves the privacy of the user account and even those engaging in digital piracy. The present technology merely needs to learn when the unauthorized distribution has occurred and, ideally, prevent further unauthorized distribution or playback of the content item. Therefore, the present technology can make use of zero-knowledge proof technologies whereby the present technology does not need to learn more than is needed to validate the authenticity of personalized interactions without compromising viewer privacy, adhering to stringent data protection standards. For example, the attributes of the interaction can be protected by a zero-knowledge proof, wherein the zero-knowledge proof attests to a characteristic the at least one of the attributes of the interaction without revealing the specific data, whereby the privacy of the at least the first user is maintained while confirming the authenticity of the attributes of the interaction.

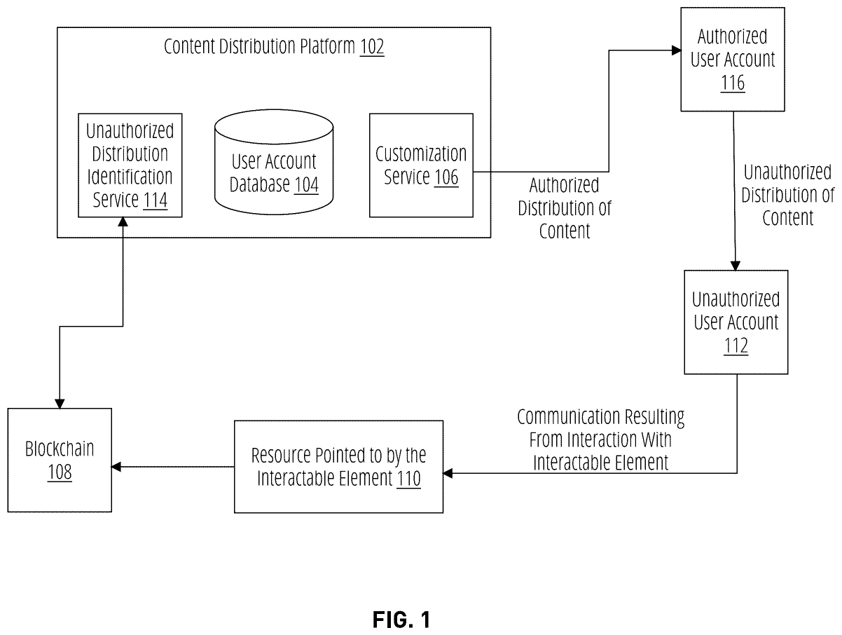

FIG. 1 illustrates an example system for implementing an unauthorized distribution detection system in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

FIG. 1 illustrates a content distribution platform 102. The content distribution platform 102 can be any provider of content. While the present description will address an embodiment of distributing visual digital media, the present technology can be used with the distribution of text, audio, video, etc., and includes both digital and non-digital distribution. The present technology applies whenever the content is distributed to an authorized user account 116, and that content includes an interactable element that is unique to the distribution of the content to the authorized user account 116.

The authorized user account 116 is generally a subscriber of the content distribution platform 102, where, through their subscription, the authorized user account 116 is entitled to authorized access and consumption of content provided by the content distribution platform 102. However, the authorized user account 116 is not authorized to further distribute the content. The authorized user account 116 can include a user profile stored in the user account database 104.

The interactable element can be anything appropriate for the content type that is unique for the distribution of the content to the authorized user account 116. For example, any visual content such as video, images, or a document could include a bar code or QR code as the interactable element, both of which will work for printed and digitally distributed content. If the content is limited to distribution to devices with pointer user interface devices and a web browser, the interactable element can be a uniform resource locator (URL). If the content is audio, the interactable element could be a spoken URL or a unique code. The interactable element should entice some portion of the users (whether authorized user accounts or unauthorized users) to want to interact with the interactable element.

In some embodiments, the interactable element entices a user to interact with it by offering a giveaway or contest (e.g., a competitive game or a lottery). Ideally, the offer is persuasive enough to induce the user to create a wallet for conducting transactions on a blockchain. However, it is still sufficient if the interactable element causes the user account to at least interact with the interactable element. For example, some minimal data collection still occurs if the user goes to the resource pointed to by the interactable element 110. For example, the user's IP address can be collected, and perhaps other attributes of the interaction like the device type, operating system type, browser, etc., and even these basic attributes of the interaction of the interaction can be enough for the unauthorized distribution identification service 114 to determine that the authorized user account 116 is undertaking an unauthorized distribution of the content. Ideally, the user will have a deeper interaction by providing additional information that can aid in a deeper understanding of the dynamics of the unauthorized distribution.

The unauthorized distribution of the content can generally take the form of the authorized user account 116 distributing the content to the unauthorized user account 112. In some embodiments, the authorized user account 116 can make an unauthorized copy and distribute that unauthorized copy directly to the unauthorized user account 112 or indirectly through a distribution platform. For example, there are several known distribution platforms that have become known for enabling unauthorized distribution of content. Some of these platforms engage in peer-to-peer distribution, which makes the termination or prevention of the unauthorized distribution impractical to the point of being completely infeasible. Even if the content distribution platform 102 were successful in preventing the unauthorized distribution of content on a platform, another platform would be created to circumvent the prevention.

While FIG. 1 illustrates that the user interacts with blockchain 108, any database can be sufficient to achieve the overarching aim of detecting unauthorized distribution of the content. However, a blockchain is preferred for several reasons. For example, a blockchain can enable a balance between uniquely identifying a user and still keeping the user anonymous. The blockchain can also be less susceptible to techniques used to obfuscate the unauthorized distribution. For example, in a basic internet transaction, a user can use VPNs and IP masks to hide or misdirect some attributes of the interaction. However, a transaction on a blockchain will require a wallet address and a signature for the transaction on the blockchain. And since the blockchain is already designed to provide anonymity of users behind their wallet addresses, there is no need for the user to take additional steps to obfuscate their identity. Yet, while the blockchain might provide anonymity to the user account, some attributes of some blockchains will actually provide the ability to detect unauthorized distribution of the content with more certainty.

The unauthorized distribution identification service 114 enables the content distribution platform 102 to at least flag a user account as being a potential source of unauthorized distribution of content. In some embodiments, the unauthorized distribution identification service 114 can also enable the content distribution platform 102 to take actions to mitigate or prevent future unauthorized distribution of content through charging the user account or terminating the privileges of the user account. In some embodiments, the unauthorized distribution identification service 114 can be responsible for analyzing data from blockchain 108 (or other type of database) to determine that an unauthorized distribution is occurring; however, in some embodiments, this function can be performed by smart contracts run on blockchain 108, which can report possible unauthorized distribution to the unauthorized distribution identification service 114. Accordingly, functions that might be attributable to the unauthorized distribution identification service 114 throughout this description can refer to functions that might be shared or delegated to services of blockchain 108.

It should be appreciated by those of ordinary skill in the art that determining that an unauthorized distribution of content has taken place can be a difficult technical problem on its own, even when the content distribution platform 102 has access to attributes of the interaction for consumption of the content. This is because many subscriber agreements might allow content to be consumed on multiple devices or by multiple unique users (such as members of the same household).

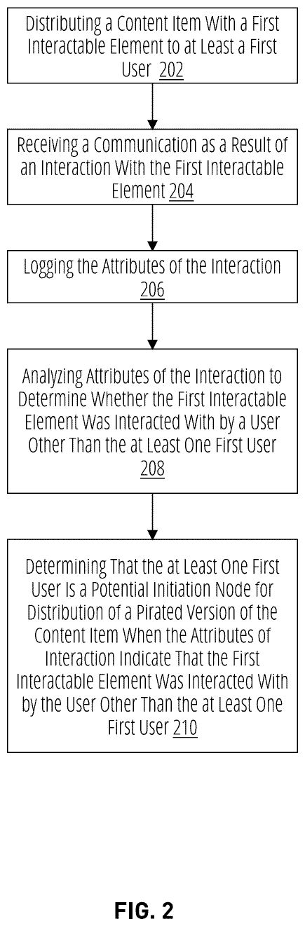

FIG. 2 illustrates an example routine for detecting unauthorized distribution of digital content in accordance with some embodiments of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes distributing a content item to at least a first user at block 202. For example, the content distribution platform 102 illustrated in FIG. 1 may distribute a content item with a first interactable element to at least the first user. The first user is typically an authorized user account that has a subscription or has otherwise obtained rights to consume the content item at least once.

In some embodiments, the first interactable element is unique to the first user such that all content distributed to the first user includes the same interactable element. In some embodiments, the first interactable element is unique to the distribution of the content item to the first user such that any unauthorized distribution of the content item can be traced to the union of that content item and the first user. Accordingly the content distribution platform 102 can also distribute a second content item to a second user with a second interactable element where the first interactable element and the second interactable element are different.

In some embodiments, the first interactable element to be associated with the content item distributed to the at least the first user is configured to entice the at least the first user to engage with the first interactable element. For example a personalization service can predict what giveaway or contest would be attractive to consumers of the content item.

In some embodiments, the first interactable element is a SMS interaction that is designed with a unique phone number or a unique starting code within the message that is specific to the account of the at least the first user, whereby precise tracking of responses is enabled and helps identify unusual patterns such as multiple responses from different geographic locations which indicate unauthorized distribution. In some embodiments, the first interactable element is a QR Code that is dynamically generated when the content item is requested by the at least the first user, the QR Code includes an embedded identifier that is unique to the at least the first user, whereby a single digit or character variation in the QR Code ensures each viewer's interaction is uniquely trackable without compromising the privacy of the at least the first user or the user experience. In some embodiments, the first interactable element is a trivia game or poll that is personalized to the at least the first user, the trivia game or poll is tailored to be compatible with the content item, whereby the personalization of the trivia game or poll can be used to detect synchronized interactions from cloned accounts or distributed pirated content. In some embodiments, the first interactable element is an invitation to provide a voice command, wherein the voice command can be analyzed to compare with a known profile for the at least the first user, whereby a discrepancy compared to the known profile for the at least the first user indicates a possible anomaly in distribution of the content item. In some embodiments, the first interactable element is a social media link, wherein an interaction with the social media link can be compared with a known account of the at least the first user, whereby a discrepancy compared to the known account for the at least the first user indicates a possible anomaly in distribution of the content item.

A variety of reward mechanisms can serve as effective enticements for users to interact with the interactable element. One such reward mechanism includes a giveaway like the distribution of non-fungible tokens (NFTs), which are unique digital assets that represent ownership of items such as art, music, or collectibles. The appeal of NFTs lies in their exclusivity and the potential for appreciating value. Another giveaway reward mechanism can include distributing small amounts of tokens, including meme coins or other cryptocurrencies on Layer-2 chains. These tokens can be utilized within specific ecosystems or exchanged in broader markets, providing users with an accessible entry point into the cryptocurrency landscape. Another reward mechanism can include offering users entries into contests like blockchain-based lotteries, which operate without centralized control and employ smart contracts to ensure transparency and fairness. Another reward mechanism can include engaging in blockchain-based games where interactions and achievements in the game can be recorded on the blockchain.

All of these reward mechanisms can be governed by smart contracts. Smart contracts are self-executing contracts with the terms of the agreement written directly into code. They automatically execute and enforce predefined conditions when specific criteria are met, without the need for intermediaries. Smart contracts offer several advantages that bolster user confidence. The transparency aspect is underscored by the ability of users to publicly access the contract code and transaction history on the blockchain, enabling independent verification of the legitimacy of reward distributions and lottery operations. Furthermore, the automation and immutability characteristics of smart contracts ensure that predefined conditions are executed without human intervention, mitigating manipulation risks and ensuring terms remain unaltered post-deployment. In the domain of lotteries, smart contracts can utilize algorithms to randomly select winners, establishing an unbiased process that employs blockchain-based randomness to guarantee fairness. Collectively, these features enhance user confidence in the reliability and integrity of blockchain-based rewards, effectively enticing interaction with the blockchain while watching content.

While, generally, there might be a low capture rate to get users to sign up for games or provide identifiable information such as email addresses, the present technology can still achieve its objectives. First, it is expected that such reward mechanisms offered on the blockchain will have a higher response rate since many users are interested in learning about the blockchain but have not found the right entry point. Second, even a low response rate can be sufficient to identify many unauthorized distributions since the scale of unauthorized distributions is generally large on some platforms. Even a small minority of users that download the content can be enough to highlight a source user account that initiated the unauthorized distribution. Third, even if a user looks at the reward mechanism by interacting with the first interactable element, this can be enough to get some information about the link caller, even if it is not as much information as can be gathered by the user engaging with the reward mechanism (e.g., signing up for the reward).

According to some examples, the method includes receiving a communication as a result of an interaction with the first interactable element at block 204. For example, the resource pointed to by the interactable element 110 illustrated in FIG. 1 may receive the communication as a result of the interaction with the first interactable element. In some embodiments, the resource pointed to by the interactable element 110 can be a URL that guides a user through signing up for the giveaway or contest.

In some embodiments, the giveaway or content might require the user to provide their digital wallet address. If a user does not want to provide their existing digital wallet address or doesn't have a digital wallet, the resource pointed to by the interactable element 110 can guide the user through creating a digital wallet. In some examples, a user can create a digital wallet by linking to an authentication provider, such as an authentication provider that participates in the OpenID standard. Thereby, the user can use their Web 2.0 login to create a Web3 digital wallet.

The resource pointed to by the interactable element 110 can further guide the user through the completion of signing up for the giveaway or contest by causing the user to engage in a transaction that is recorded on the blockchain 108.

According to some examples, the method includes logging the attributes of the interaction at block 206. For example, the blockchain 108 illustrated in FIG. 1 may log the attributes of the interaction. Even when the user declines to engage in blockchain transaction to sign up for the giveaway or contest, some attributes of the interaction can be recorded by the resource pointed to by the interactable element 110. For example, a minimal set of attributes of the interaction can include a time of interaction, an identification of the first interactable element, and user device attributes (e.g., the IP address of a computing device used to perform the interaction, operating system, device type, and/or broad location attributes (city, state, or country), connection type, etc.). And when the user does engage in the giveaway or contest, the attributes of the interaction can include at least the wallet address along with any other information that the user might have provided while signing up for the giveaway or contest.

According to some examples, the method includes analyzing attributes of the interaction to determine whether the first interactable element was interacted with by a user other than the at least one first user at block 208. For example, the blockchain 108 and/or the unauthorized distribution identification service 114 illustrated in FIG. 1 may analyze attributes of the interaction to determine whether the first interactable element was interacted with by a user other than the at least one first user.

In some embodiments, the content distribution platform 102 can have associated the giveaway or contest with one or more smart contracts (e.g., a smart contract that controls the giveaway or contest and a smart contract that contributes to the analysis of the attributes of the interaction). Thereby, whenever a user attempts to write a block to the blockchain 108 that is associated with the giveaway or contest, the smart contract can take actions indicated by the smart contract. As addressed above, one function of the smart contract can be to govern the rules around the giveaway or contest. The terms of this smart contract are typically publicly viewable.

In some embodiments, an additional smart contract can report signups for the giveaway or contest along with the attributes of the interaction to the unauthorized distribution identification service 114. In some embodiments, the smart contract can search for other blocks on the blockchain 108 that are associated with the same identifier of the first interactable element since all blocks that reference the first interactable element likely pertain to the distribution of the content by the authorized user account 116 to whom the content was provided. In some embodiments, the smart contract could include logic to identify when unauthorized distribution occurred. Such logic might pertain to a number of blocks that reference the first interactable element, and that reference unique wallet addresses. In some embodiments, the smart contract that reports signups for the giveaway or contest or that identifies when unauthorized distribution occurred can be a private smart contract such that the terms and function of the smart contract are not publicly viewable.

An example of how a smart contract might function to report signups for the giveaway or contest or that identifies when unauthorized distribution occurred, can be a smart contract that is triggered whenever a transaction is written to the blockchain that references the giveaway or contest. In response to being triggered, the smart contract can call an oracle or other resource that is aware of the identifier associated with the first interactable element because the content distribution platform 102 has recorded the identifier with the oracle or other resource. When the smart contract determines that the identifier from the content distribution platform 102 recorded with the oracle or other resource matches the identifier associated with the first interactable element, the smart contract can send a notification to the unauthorized distribution identification service 114 of the content distribution platform 102.

The attributes of the interaction that can be extracted from the blockchain data can depend on details of the implementation. However, a minimum amount of data can be at least a wallet address. Additional data can include the identifier associated with the first interactable element, the consuming users email address, the identity verification provider used to identify the user to the wallet, an IP address, a computer operating system, a device type, and more.

In some embodiments, although the content of the blocks written to the blockchain might be encrypted, the block validators can read the blocks to extract some of the data before they are stored on the blockchain. This can be helpful to learn information about the user and in particular, to determine if the user is the first user that was authorized to receive the content or is it another user that received the content item as part of an unauthorized distribution of the content item.

The unauthorized distribution identification service 114 can receive whatever information the smart contract or the resource pointed to by the interactable element 110 forwards to the unauthorized distribution identification service 114 and determine whether an unauthorized distribution of the content item occurred and/or whether any action should be taken to mitigate future unauthorized distribution of the content item.

In some embodiments, at least one of the attributes of the interaction are protected by a zero-knowledge proof. This can be useful in embodiments where user identifying information is recorded as part of the signup for the giveaway or contest. The zero-knowledge proof attests to a characteristic the at least one of the attributes of the interaction without revealing the specific data. The zero-knowledge proof can maintain the privacy of the at least the first user while confirming the authenticity of the attributes of the interaction. As an example, the zero-knowledge proof might attest that the giveaway or contest was registered to an email address that is not an email address used to subscribe to the service, without providing the users actual email address.

Determining that an unauthorized distribution of a content item has occurred can be a complex process and can depend on what type of data is available. For example, it can be determined that an unauthorized distribution has occurred if enough different IP addresses have attempted to sign up for the giveaway or contest within a short enough period that it would be highly improbable that all signups were from users participating in authorized consumption of the content item. In another example, the different user accounts might provide an email address, which can be used to determine when different wallet addresses are associated with the same email address. Thereby, some number of signups for the giveaway or contest that appear unique by wallet address might be determined to be associated with the same user. In some embodiments, if a user does not reveal their email account, it might still be possible to learn of the host of their email account when the host was used to verify the user's identity to log in to the wallet. In this way, anonymity of the user can be preserved as the user might expect in a blockchain transaction, but some information about their authentication provider might be learned.

In some embodiments, the analyzing the attributes of the interaction includes using a machine learning algorithm to analyze the attributes for signs of unauthorized distribution.

According to some examples, the method includes determining that the at least one first user is a potential initiation node for the distribution of a pirated version of the content item when the attributes of interaction indicate that the first interactable element was interacted with by the user other than the at least one first user at block 210. For example, the unauthorized distribution identification service 114 illustrated in FIG. 1 may determine that the at least one first user is a potential initiation node for the distribution of a pirated version of the content item when the attributes of interaction indicate that the first interactable element was interacted with by the user other than the at least one first user.

Whether by a smart contract or the unauthorized distribution identification service 114 or both, heuristics or machine learning can be used to make a determination that an unauthorized distribution has occurred.

When it is determined that an unauthorized distribution has occurred, the unauthorized distribution identification service 114 can take action, if desired, by suspending the account of the first user.

In some embodiments, such as when the unauthorized distribution identification service 114 is able to learn the email addresses of the authorized user account 116, the unauthorized distribution identification service 114 can send communications warning that users consuming the content items that they are engaging in intellectual property infringement or theft.

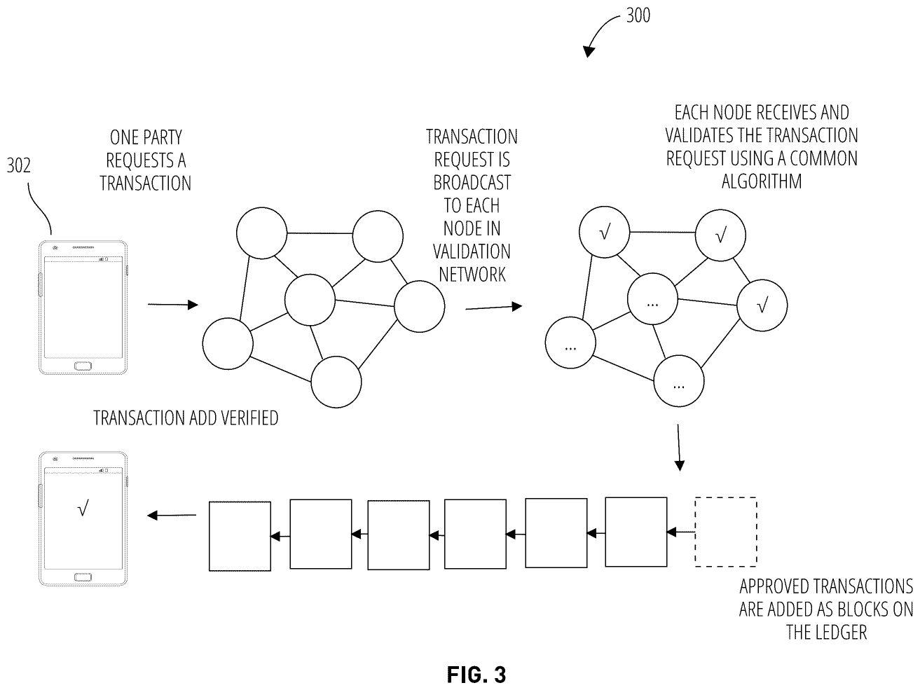

Referring to FIG. 3, a blockchain is an ever-growing set of data blocks. Each block records a collection of transactions. Blockchains distribute these transactions across a group of computers. Each computer maintains its own copy of the blockchain transactions.

A blockchain is a continuously growing list of records, called blocks, which are linked and secured using cryptography. Each block typically comprises a cryptographic hash of the previous block, a timestamp, and transaction data. By design, a blockchain is resistant to modification of the data. Blockchains may implement an open, distributed ledger that can record transactions between two parties efficiently and in a verifiable and permanent way.

A blockchain is typically managed by multiple parties collectively adhering to a protocol for inter-node communication and validating new blocks. Once recorded, the data in any given block cannot be altered retroactively without alteration of all subsequent blocks, which requires consensus among the operators.

Cryptography involving mathematical methods of keeping data secret and proving identity is utilized when recording transactions. One digital key ensures only an owner can enter a transaction to the blockchain involving their assets, and another digital key lets other parties confirm it really was the owner who added the transaction.

Blockchain is resistant to tampering or other changes by utilizing a cryptographic technique called the hash. Hashing reduces data to a sequence of seemingly random characters—for example, the hash of the phrase “the quick brown fox” is “9ECB36561341D18EB65484E833EFEA61EDC74B84CF5E6AE1B81C63533E25FC8F” using a hash method called SHA-256. Tweaking just one letter in the phrase produces a completely different hash, and you can't go backward to figure out the original data from the hash.

With blockchain, hashes are linked together so any minute change is immediately visible, not just for the block housing it but for all other blocks added later. With red flags that big for changes that small, auditing becomes easier.

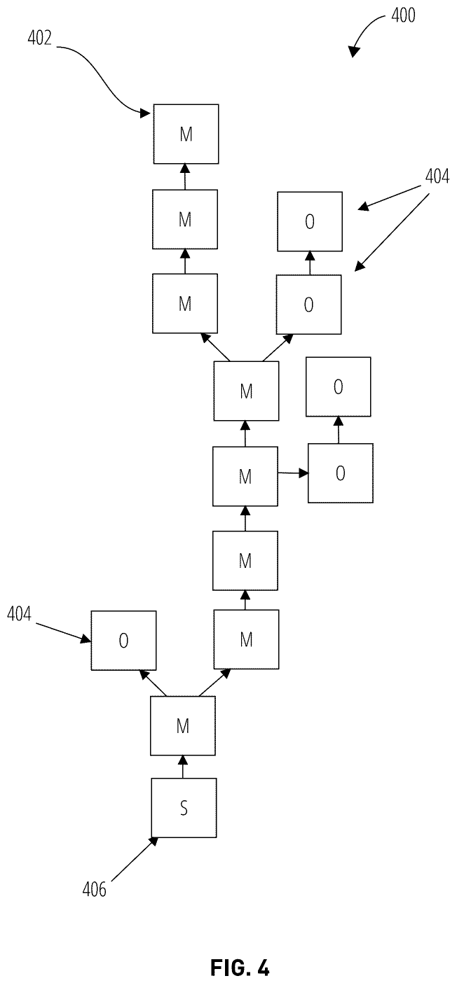

FIG. 4 illustrates an exemplary blockchain formation 400. The mainchain 402 (M blocks) comprises the longest series of blocks from the start block 406 (S block) to the current block. Orphan blocks 404 (O blocks) exist outside of the main chain.

Blocks hold batches of valid transactions that are hashed and encoded, for example into a Merkle tree. Each block includes the cryptographic hash of the prior block in the blockchain formation 400, linking the two. The linked blocks form a chain. This iterative process confirms the integrity of the previous block, all the way back to the original start block 406.

Sometimes separate blocks can be produced concurrently, creating a temporary fork. In addition to a secure hash-based history, the blockchain formation 400 has a specified algorithm for scoring different versions of the history so that one with a higher value can be selected over others. Blocks not selected for inclusion in the mainchain 402 are called orphan blocks 404. Peers supporting the blockchain formation 400 have different versions of the history from time to time. They keep only the highest-scoring version of the blockchain formation 400 known to them. Whenever a peer receives a higher-scoring version (usually the old version with a single new block added) they extend or overwrite their local version of the blockchain formation 400 and retransmit the improvement to their peers. There is never an absolute guarantee that any particular entry will remain in the best version of the history forever. Because blockchains are typically built to add the score of new blocks onto old blocks and because there are incentives to work only on extending with new blocks rather than overwriting old blocks, the probability of an entry becoming superseded goes down exponentially as more blocks are built on top of it, eventually becoming very low. For example, in a blockchain using the proof-of-work system, the chain with the most cumulative proof-of-work is always considered the valid one by the network. There are a number of methods that can be used to demonstrate a sufficient level of computation. Within a blockchain the computation is carried out redundantly rather than in the traditional segregated and parallel manner.

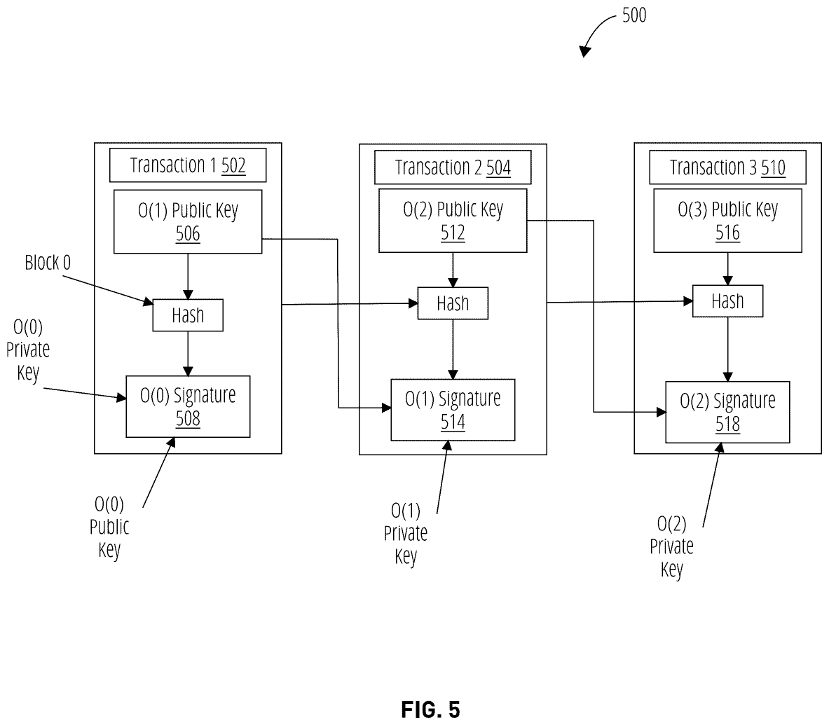

FIG. 5 illustrates an embodiment of an irreversible transaction blockchain 500. The blockchain 500 is a sequence of digitally signed transactions (transaction 1 502, transaction 2 504, and transaction 3 510 etc.). Each transaction includes the current owners public key (block 1 owner public key 506, block 2 owner public key 512, and block 3 owner public key 516 respectively) and the previous owner's signature (O(0) signature 508, O(1) signature 514, and O(2) signature 518) which are generated using a hash function. The owner of a transaction can examine each previous transaction to verify the chain of ownership. Unlike traditional check endorsements, the transactions in the blockchain 500 are irreversible, which mitigates fraud.

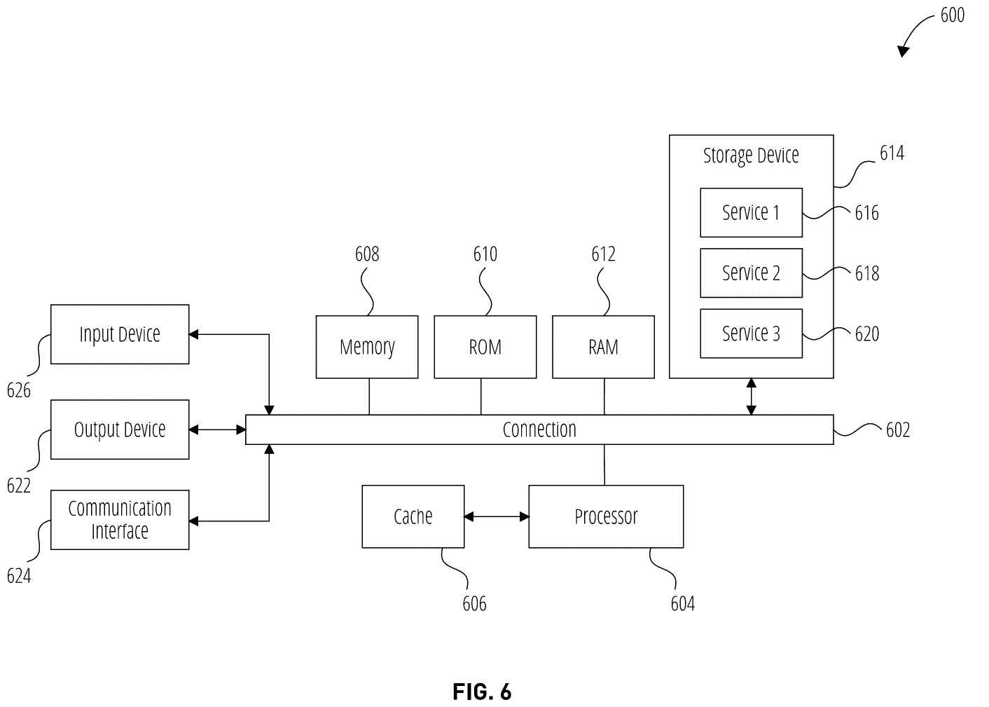

FIG. 6 shows an example of computing system 600, which can be for example any computing device, or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) 604 and connection 602 that couples various system components including system memory 608, such as read-only memory (ROM) 610 and random access memory (RAM) 612 to processor 604. Computing system 600 can include a cache of high-speed memory 606 connected directly with, in close proximity to, or integrated as part of processor 604.

Processor 604 can include any general purpose processor and a hardware service or software service, such as services 616, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc. Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that performs a particular function can include the software component stored in a computer-readable medium in connection with the necessary hardware components, such as processor 604, connection 602, output device 622, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for preventing content item piracy, the method comprising:
distributing a content item to at least a first user with a first interactable element;
distributing the content item to at least a second user with a second interactable element, wherein the first interactable element and the second interactable element are different;
receiving a communication as a result of an interaction with the first interactable element or the second interactable element;
analyzing attributes of the interaction to determine whether the first interactable element was interacted with by a user other than the at least one first user;
determining that the at least one first user is a potential initiation node for an unauthorized distribution of the content item when the attributes of interaction indicate that the first interactable element was interacted with by an unauthorized user.

2. The method of claim 1, wherein the first interactable element is specific to the first user.

3. The method of claim 2, wherein a personalization service selects the first interactable element to be associated with the content item distributed to the at least the first user, wherein the first interactable element is configured to entice the at least the first user to engage with the first interactable element.

4. The method of claim 1, wherein the second interactable element is specific to the second user.

5. The method of claim 1, wherein the first interactable element is a SMS interaction that is designed with a unique phone number or a unique starting code within the message that is specific to the account of the at least the first user.

6. The method of claim 1, wherein the first interactable element is a QR Code that is dynamically generated when the content item is requested by the at least the first user, the QR Code includes an embedded identifier that is unique to the at least the first user.

7. The method of claim 1, wherein the first interactable element is a trivia game or poll that is personalized to the at least the first user.

8. The method of claim 1, wherein the first interactable element is an invitation to provide a voice command, wherein the voice command can be analyzed to compare with a known profile for the at least the first user, whereby a discrepancy compared to the known profile for the at least the first user indicates a possible anomaly in distribution of the content item.

9. The method of claim 1, wherein the first interactable element is a social media link, wherein an interaction with the social media link can be compared with a known account of the at least the first user, whereby a discrepancy compared to the known account for the at least the first user indicates a possible anomaly in distribution of the content item.

10. The method of claim 1, further comprising:
logging the attributes of the interaction, wherein the attributes of the interaction include a time of interaction, an identification of the first interactable element, and location data of a computing device used to perform the interaction.

11. The method of claim 1, wherein the analyzing the attributes of the interaction includes using a machine learning algorithm to analyze the attributes for signs of unauthorized distribution, wherein examples of unauthorized distribution include the use of a personalized QR code from multiple locations or multiple responses to a uniquely coded SMS message.

12. The method of claim 10, wherein the logging of the attributes of the interaction is storing the attributes of the interaction on a blockchain.

13. The method of claim 1, wherein at least one of the attributes of the interaction are protected by a zero-knowledge proof, wherein the zero-knowledge proof attests to a characteristic the at least one of the attributes of the interaction without revealing the specific data.
